(19) United States
(12) Patent Application Publication
(10) Pub. No.: US 2022/0074137 A1
(43) Pub. Date: Mar. 10, 2022

(54) WIRE LUBRICATION APPLICATORS, AND RELATED METHODS OF USE

(71) Applicant: 1187185 ALBERTA LTD., Medicine Hat (CA)

(72) Inventor: Blaire Velichko, Medicine Hat (CA)

(21) Appl. No.: 17/467,423

(22) Filed: Sep. 6, 2021

(30) Foreign Application Priority Data
Sep. 4, 2020 (CA) 3,092,147

(51) Int. Cl. D07B 7/12; F16N 1/00; F16N 7/14

(52) U.S. Cl. CPC D07B 7/12; F16N 2210/34; F16N 7/14; F16N 1/00

(57) ABSTRACT

A wire lubrication applicator has: a cylindrical body with opposed open axial ends along a wire travel axis, the cylindrical body formed of inner and outer hollow tubes that each define a longitudinal wire insertion slot extending between the opposed open axial ends, with the inner and outer hollow tubes being coaxially mounted to rotate relative to one another about the wire travel axis to align and misalign the longitudinal wire insertion slots to open and close, respectively, a lateral wire entry into a lubricant retaining interior of the inner hollow tube; and one or more end caps that are on the cylindrical body and each form an axial wire opening. One or more of the axial wire openings are biased to radially constrict about a wire in use.

### TECHNICAL FIELD

This document relates to wire lubrication applicators and related methods of use.

### BACKGROUND

The following paragraphs are not an admission that anything discussed in them is prior art or part of the knowledge of persons skilled in the art. Wire lubricant is dispensed along a wire by hand, using brushes, or using a slotted canister with a lubricant-soaked sponge.

### SUMMARY

A wire lubrication applicator is illustrated comprising: a cylindrical body with opposed open axial ends along a wire travel axis, the cylindrical body formed of inner and outer hollow tubes that each define a longitudinal wire insertion slot extending between the opposed open axial ends, with the inner and outer hollow tubes being coaxially mounted to rotate relative to one another about the wire travel axis to align and misalign the longitudinal wire insertion slots to open and close, respectively, a lateral wire entry into a lubricant retaining interior of the inner hollow tube; and one or more end caps that are on the cylindrical body and each form an axial wire opening. The applicator may form a sealed cylindrical body when closed.

In some cases, one or more of the axial wire openings are biased to radially constrict about a wire in use.

A wire lubrication applicator is also disclosed comprising: a cylindrical body with opposed open axial ends along a wire travel axis, the cylindrical body formed of inner and outer hollow tubes that each define a longitudinal wire insertion slot extending between the opposed open axial ends, with the inner and outer hollow tubes being coaxially mounted to rotate relative to one another about the wire travel axis to align and misalign the longitudinal wire insertion slots to open and close, respectively, a lateral wire entry into a lubricant retaining interior of the inner hollow tube; and one or more end caps that are on the cylindrical body and each form an axial wire opening, with one or more of the end caps having a plurality of converging radial fingers that define the respective axial wire opening.

A method is also disclosed of using a wire lubrication applicator, the method comprising: inserting a wire laterally through the lateral wire entry into the lubricant retaining interior, through the aligned longitudinal wire insertion slots of the inner and outer hollow tubes; and translating the wire lubrication applicator axially along the wire to dispense lubrication material from the lubricant retaining interior onto the wire.

A wire lubrication applicator is disclosed comprising: a cylindrical body formed of inner and outer hollow tubes, the cylindrical body defining a wire travel axis between opposed open axial ends, and through a lubricant retaining interior, of the cylindrical body, each of the inner and outer hollow tubes defining a cylindrical wall, with the inner hollow tube defining the lubricant retaining interior and being sized and fitted concentrically within the outer hollow tube, and with the cylindrical walls of the inner and outer hollow tubes each defining a longitudinal wire insertion slot extending between the opposed open axial ends, in which the inner hollow tube is fitted to rotate coaxial and relative to the outer hollow tube between: a) an open angular position where the longitudinal wire insertion slots align to permit a wire to be inserted laterally into the lubricant retaining interior; and b) a closed angular position; and one or more end caps, on the cylindrical body, with one or more of the end caps forming an axial wire opening that is biased to radially constrict about a wire in use.

In various embodiments, there may be included any one or more of the following features: The one or more end caps comprise: a wire exit cap at a wire exit end of the opposed open axial ends; and a wire entry cap at a wire entry end of the opposed open axial ends. One or more of the end caps have a plurality of converging radial fingers that define the respective axial wire opening. The one or more of the end caps that have a plurality of converging radial fingers further comprises inner and outer end caps nested coaxially with one another. The inner end cap is connected to the inner hollow tube, and the outer end cap is connected to the outer hollow tube. When the lateral wire entry is closed, the inner and outer end caps are angularly displaced relative to one another such that the plurality of converging fingers of the outer end cap overlaps radial gaps between adjacent of the plurality of converging fingers of the inner end cap. One or more of the end caps are reversibly detachable from the lubrication applicator. One or more of the end caps are movable between an open position and a closed position. One or more of the end caps are mounted to slide around a longitudinal axis parallel to the wire travel axis of the cylindrical body between the open position and the closed position. A handle is present. The handle extends radially outward off of the cylindrical wall of the inner hollow tube. The handle is mounted to rotate the inner hollow tube about the wire travel axis along an angular slot defined in a cross-sectional arc along the cylindrical wall of the outer hollow tube. The inner and outer hollow tubes are between 2-5 inches in diameter and 10-18 inches in length. A lubrication dispensing cartridge is present within the inner hollow tube. The lubrication dispensing cartridge defines a longitudinal wire insertion slot that extends between opposed open axial cartridge ends and aligns with the longitudinal wire insertion slots of the inner and outer hollow tubes when the lateral wire entry is open. The longitudinal wire insertion slots are commensurate in cross-sectional arc length with one another. Each longitudinal wire insertion slot has a cross-sectional arc length of 45 degrees or less. Lubrication compound is within the lubricant retaining interior. Before translating, charging the lubricant retaining interior with lubrication material. Before translating, rotating the inner and outer hollow tubes coaxially relative to one another to close the lateral wire entry. One of the end caps is structured to grip the wire. One of the end caps is structured to permit axial translation of the wire in a first axial direction along the wire and grip the wire when attempted to be axial translated along the wire in a second axial direction opposite the first direction.

The foregoing summary is not intended to summarize each potential embodiment or every aspect of the subject matter of the present disclosure. These and other aspects of the device and method are set out in the claims.

### BRIEF DESCRIPTION OF THE FIGURES

Embodiments will now be described with reference to the figures, in which like reference characters denote like elements, by way of example, and in which:

FIGS. 1A and 1B are side elevation views showing a wire lubrication applicator with concentric hollow tubes in an open and closed position, respectively, with a wire shown in FIG. 1B.

FIG. 2 is a close up side elevation view of the wire lubrication applicator of FIG. 1A illustrating the operation of a handle on the inner hollow tube, and a lanyard connected to the outer hollow tube.

FIG. 3 is a section view, of an exit end of the wire lubrication applicator of FIG. 1A, illustrating the accommodation of radial fingers for wires of different diameters, with solid and dashed lines used to illustrate a smaller and larger diameter wire, respectively, and the resulting effect on the fingers.

FIGS. 4A and 4B are end elevation views of the wire lubrication applicator of FIGS. 1A and 1B, respectively, illustrating the hollow tubes in the open and closed positions, respectively, and with dashed lines to illustrate internal components.

FIGS. 4C and 4D are end elevation views corresponding to FIGS. 4A and 4B, with the dashed lines removed for clarity.

FIGS. 5A and 5B are side elevation views or another embodiment of a wire lubrication applicator, having a tapered end and a sliding disc end cap to accommodate an internal lubricant cartridge, with the applicator shown in FIGS. 5A and 5B in the open and closed positions, respectively.

FIGS. 6A and 6B are end elevation views of the wire lubrication applicator of FIG. 5A, illustrating the sliding disc end cap in the open and closed position, respectively.

FIG. 7 is a perspective view of a lubricant cartridge to be used with the embodiment of FIGS. 6A and 6B.

FIG. 8 is an end elevation view of a tapered axial end of the wire lubrication applicator of FIG. 6A.

FIG. 9 is a side elevation view of another embodiment of a wire lubrication applicator having a larger handle than in FIG. 1A.

FIGS. 10 and 11 are side elevation views, partially in section, of another embodiment of a wire lubrication applicator, with an end cap permitting axial translation of the application over the wire(s) in a first direction (FIG. 10), and the end cap gripping the wire(s) to restrict or prohibit axial translation in a second direction opposite the first direction.

### DETAILED DESCRIPTION

Immaterial modifications may be made to the embodiments described here without departing from what is covered by the claims.

A lubricant is a substance, usually but not limited to organic compounds, introduced to reduce friction between surfaces in mutual contact, which ultimately reduces the heat generated when the surfaces move or to facilitate relative movement. It may also have the function of transmitting forces, transporting foreign particles, or heating or cooling surfaces. The property of reducing friction is known as lubricity. In addition to industrial applications, lubricants are used for many other purposes. Other uses include cooking (oils and fats in use in frying pans, in baking to prevent food sticking), bioapplications on humans (e.g. lubricants for artificial joints), ultrasound examination, medical examination. Lubricants are mainly used to reduce friction and to contribute to a better and efficient functioning of a mechanism.

Running individual wires through a conduit may be a difficult task if the conduit run is long or has bends in it. To facilitate installation of wires (including cables) in such a context, a wire-pulling compound or lubricant (lube) may be used. Wire-pulling compounds may be nonconductive or electrically neutral, making them safe for electrical work and all types of electrical or pneumatic wiring. Wire lube may be one or more of odorless, non-toxic, and non-corrosive and does not require skin protection. However, using lubricant is not without some risk. Lubricant may be slippery, and a user ought to be cautious not to get any on his or her shoes. Spilling lube on ladder steps or rungs may be particularly hazardous. Most lubes clean up easily with soap and water and leave no residue. Wire-pulling compound, also called wire lube or lubricant, is designed to make it easier to pull electrical wires through conduit runs. Such compound may come in a few different forms and reduces the coefficient of friction between wires and conduits to help minimize damage to the wire insulation or wire jackets and make pulling smoother, safer, and faster.

There are several main types of wire-pulling lubricant: liquid, gel, and wax, although others may be used. Liquid lubricant may be poured into a conduit along with the wiring and drips from exposed wiring. For this reason, liquid is best for vertical or downhill runs of conduit when it might be convenient to pour the liquid into the conduit. There are also liquid lubricants in spray form. Gel lubricants may be applied to wiring before it enters the conduit and does not drip off like liquid lubes. Gel is best for overhead applications or wherever dripping lube is problematic. Wax lubricants perform similarly to gel lubes (i.e. they stick to wires and do not drip) but may be more heat-tolerant than gels, making them preferable for hot-weather situations.

Wire-pulling compound may be added to wires as they are being pulled into the conduit. The person feeding the wires may make sure the wires go straight into the conduit, using one hand to lube the wires at the same time. Spray-type lubricant may be sprayed onto the wires directly as it is being fed, leaving hands free of slippery lubricant.

There may be various types of equipment that benefit from the usage of lubricating oil for proper functioning. For example, a wire rope, which comprises a plurality of wire that is twisted into multi-wire strands and that form a conduit in the center, and used in drag lines, elevators, suspension bridges, hoists and marine tow ropes may require the use of lubricating oil to extend the lifespan of equipment. Wire ropes may comprise steel, rope or plastics, or other materials, based on the intended use of the wire rope. Sheathing wires, an electrical wire that has various insulated strands enclosed in an exterior sheath, may also benefit from the usage of lubricating oil, for example in the wire in an automobile that connects the dashboard to the speedometer to measure the rate of speed an individual is travelling.

As above, wire lubrication, also known as the process of adding a lubricating oil to a wire to promote unrestricted movement, may be used extend the lifespan of the equipment by preventing damage. A wire rope may undergo frictional stress, for example when undergoing straight, linear or lateral movement for use in an elevator or around a drum. The frictional stress on the cable or wire during use may be the result of individual wires, which are twisted on top of each other, moving over each other to facilitate the desired movement. This frictional stress from cables or wires repeatedly coming into contact and rubbing with other another may cause damage to the wires, therefore resulting in a reduced lifespan of the material over time. Wire lubrication may reduce such frictional stress by reducing tension. Wire lubrication may further provide corrosion protection in the core and inside wires and on the exterior surfaces, for example if a wire is used on a ship or suspension bridge above water. Wire lubrication may occur with the initial installation of the wire, but may be applied regularly to extend the working life of the product as the lubricant may dissolve.

Prior methods of applying lubricating oil to a wire may include manual techniques, for example using one's hands, or mechanical with the use of machinery such as brushes or canisters. Manual methods may include dipping the wire or wire into a pail of the desired lubricant, using a brush to paint on the lubricant, or applying the lubricant with one's hands while another individual pulls the wire to ensure coating of the lubricating oil throughout. Manual methods, such as the examples noted above, may be inefficient as there is the risk of a loss of lubricating oil, reduced safety of work environment, and/or extensive cleanup if oil falls onto the ground or on other machinery. Mechanical methods for apply lubricating oil may involve the use of pressurized machinery, where the lubricating oil is under pressure forcing it onto the wire, for example through the use of a spray gun. Pressurized machinery may also be inefficient for lubricating oil application, as the incorrect amount of pressure applied may result in lubricating oil failing to reach the wire or reaching beyond, therefore failing to have lubricating oil properly applied. It may also be difficult to achieve uniform application of lubricating oil if a spray jet directly impinges only the middle of the wire.

A wire lubricant, which is a substance used to reduce friction between surfaces in mutual contact, may comprise various compounds, such as petrolatum, asphaltic, grease, petroleum oils or vegetable-oil based oils. Petrolatum compounds may be translucent, which may allow a technician to perform visible inspection during application, in contrast to asphaltic compounds, which may dry to a dark surface. Wire lubricant greases may include sodium, lithium, lithium complex or aluminum complex soaps, or other suitable compounds. Wire lubricants may be selected to either penetrate or coat the wire. A penetrating lubricant may contain an evaporative solvent that facilitates mitigation of the lubricant into the core of the wire rope before evaporating, leaving a lubricating film that protects and lubricates each strand. Coating lubricants may work to seal the outside of the wire from moisture by only slightly penetrating the wire, therefore reducing wear, rust and corrosion.

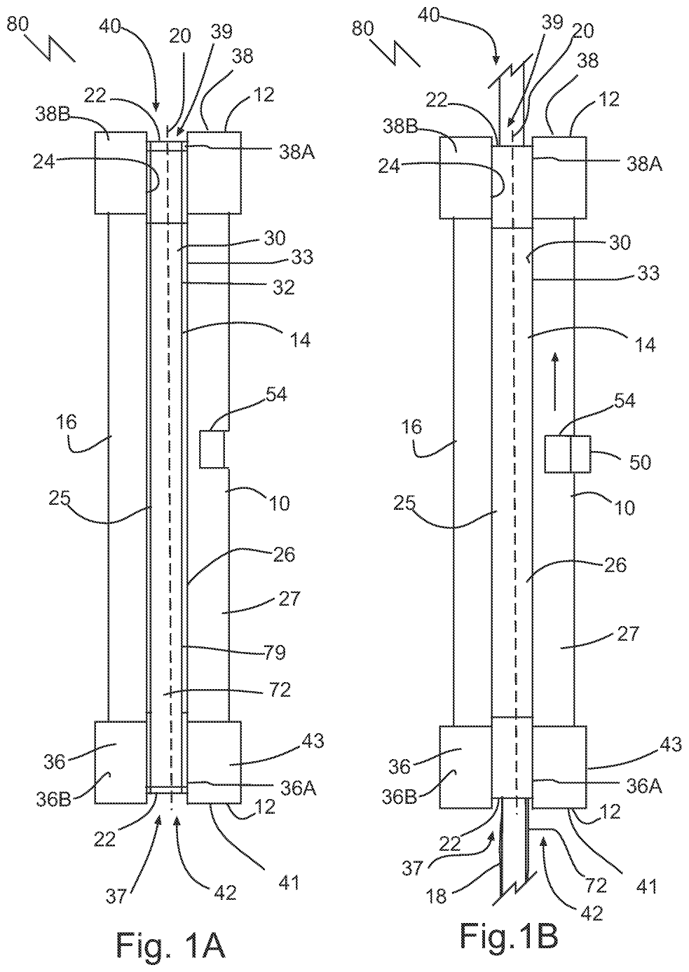

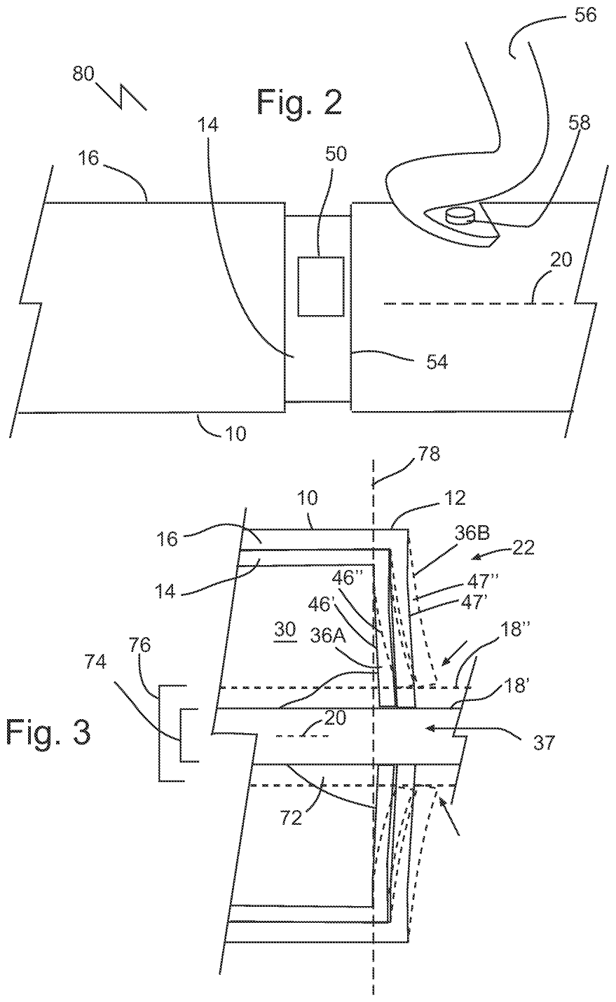

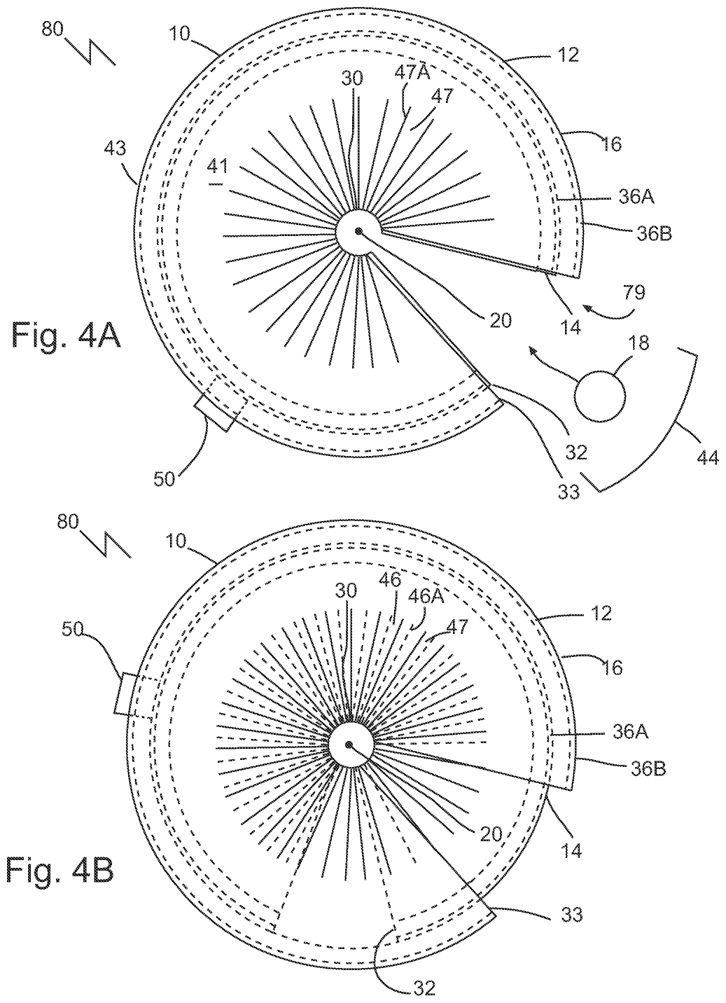

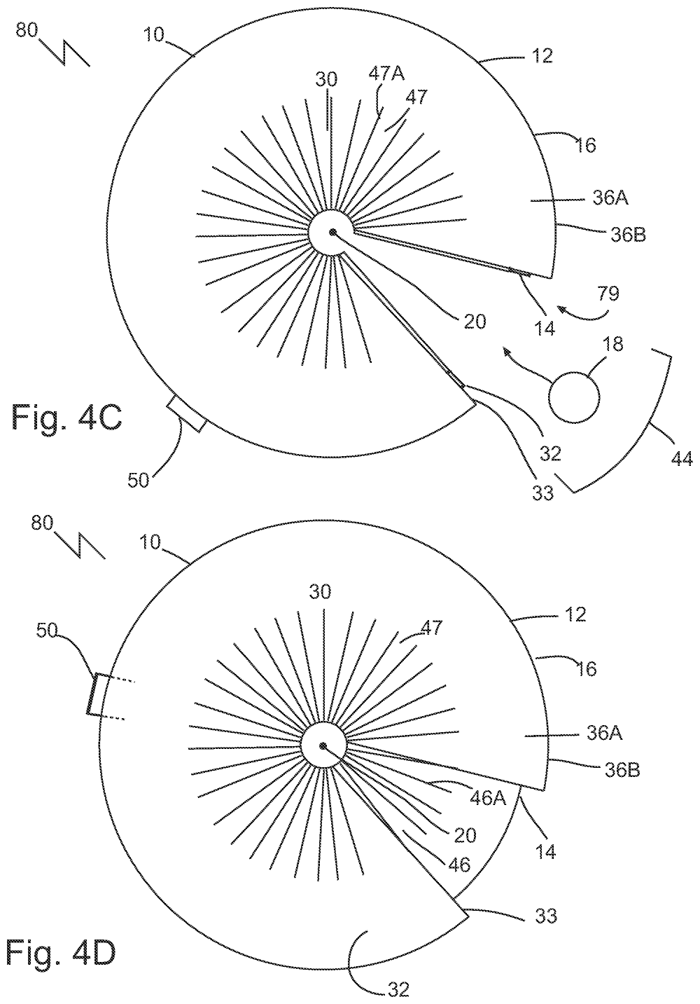

Referring to FIGS. 1A-B and 4A-D, a wire lubrication applicator 80 may have a cylindrical body 10 and one or more end cap 12. The lubrication applicator may be used to apply lubrication to a wire. The cylindrical body 10 of the wire lubrication application 80 may have opposed open axial ends 22 along a wire travel axis 20. The body 10 may be formed of an inner hollow tube 14 and an outer hollow tube 16. The inner hollow tube 14 and outer hollow tube 16 may define the wire travel axis 20, as shown by a dashed line, and opposed open axial ends 22. Each of the inner tube 14 and outer hollow tube 16 may have a cylindrical wall 26 and may define an interior 24 by which a wire 18 may travel during use. The inner and outer hollow tubes 14 and 16 may each define a longitudinal wire insertion slot 32 and 33, respectively, extending between the opposed open axial ends 22. The inner and outer hollow tubes 14 and 16 may be coaxially mounted to rotate relative to one another about the wire travel axis 20 to align and misalign (FIGS. 1A and 1B, respectively), the longitudinal wire insertion slots 32 and 33 to open and close, respectively, a lateral wire entry 79 into a lubricant retaining interior of the inner hollow tube 14. The lubricant retaining interior is illustrated as the interior 24 of the inner hollow tube 14. The inner hollow tube 14 may be sized and fitted concentrically within the interior 25 of the outer hollow tube 16, with the interior 24 of the inner hollow tube 14 and opposed open axial ends 22 defining an axial wire travel passage 30. The inner hollow tube 14 may be fitted to rotate relative and coaxial to the outer hollow tube 16 between an open angular position (FIGS. 1A, 4A, and 4C) where the longitudinal wire insertion slots 32 align to permit a wire 18 to be inserted laterally into the interior 24 of the inner hollow tube 14 and a closed angular position (FIGS. 1B, 4B, and 4D). Each end cap 12 on the cylindrical body 10 may define an axial wire opening. There may be one or more end caps 12 on the cylindrical body 10.

Referring to FIGS. 1A-1B and 4A-4D, a wire lubrication applicator 80 may comprise one or more end caps 12 each having respective axial wire openings. The end caps 12 may comprise a wire exit cap 36 at a wire exit end 40 of the opposed axial ends 22. Exit cap 36 may define an axial wire opening 37. The end caps 12 may comprise a wire entry cap 38 at a wire entry end 42 of the opposed axial ends 22. Entry cap 38 may define an axial wire opening 39. Referring to FIGS. 1A-B and 3, each end cap 12 may comprise inner and outer end caps, such as inner and outer caps 36A and 36B, respectively, of exit cap 36, or inner and outer caps 38A and 38B, respectively, of entry cap 38, nested coaxially with one another. The inner end cap may be connected to the inner hollow tube 14. The outer end cap may be connected to the outer hollow tube 16. End caps may be integrally connected to or form as part of the applicator and cylindrical body 10, or may be connected via other suitable mechanisms such as via adhesives, welding, fasteners, or others. Each end cap may have a suitable structure, such as an end plate 41 perpendicular to the axis 20. Each end cap may have a collar 43, which may secure to the cylindrical body, such as by threading as an example of an end cap 12 that is reversibly detachable from the lubrication applicator 80.

Referring to FIGS. 1B, 3 and 4A-D, one or more end cap 12 may be selected or structured to fit closely around the exterior of a wire 18 in use. One or more of the axial wire openings, such as opening 37 of wire exit cap 36 shown, may be biased to radially constrict about the wire 18 in use. One or more of the end caps 12 may have a plurality of converging radial fingers, such as one or more of plural fingers 46 or 47 that define the respective axial wire opening 37. Referring to FIG. 3, in the example shown, both caps 36A and 36B have plural fingers 46 and 47, respectively, although in some cases one of the caps has fingers only, or one cap is present and the other cap is not. Referring to FIG. 3, the use of fingers that constrict may accommodate wires 18, such as wires 18′ and 18″, of a variety of different diameters 74 and 76, respectively, by contacting and flexing to fit about wire 18. In the example shown, reference numerals 46′ and 47″ are used to denote fingers flexing to fit wire 18′, and 46″ and 47″ are used to denote fingers flexing to fit a relatively larger diameter wire 18″. The fingers may flex axially outward or inward as well, as shown. In the example shown a plane 78 is drawn to emphasize the deflection of the fingers in response to contacting the exterior surface of the wire 18. The applicator 80 may thus be used to apply lubricant to wires of a range of diameters, such as 0.5 to 1 inch diameter wires, or 1.25 to 2 inch diameter wires. The applicator 80 may be sized as appropriate, for example the inner and outer hollow tubes may be between 2-5 inches in diameter and 10-18 inches in length, although other diameters and lengths larger or smaller may be used. In some cases, a close tolerance fit between the wire opening and wire 18 may be used. When the body 10 is closed, and the axial wire opening(s) contacts the wire about the circumference of the wire, with the hollow tubes 14 and 16 fitting closely, the applicator 80 forms an effective seal that prevents or restricts leakage of lubricant from the applicator 80 other than a functional residue on wire 18 exiting the applicator 80.

Referring to FIGS. 4B and 4D, the fingers may be used to reduce unintentional lubricant leakage or loss from within the applicator 80. When the lateral wire entry 79 is closed, the inner and outer end caps 36A and 36B may be angularly displaced relative to one another such that the plurality of converging fingers 47 of the outer end cap 36B may overlap radial gaps 46A between adjacent of the plurality of converging fingers 46 of the inner end cap 36A. In the same fashion, the plurality of converging fingers 46 of the inner end cap 36A may overlap radial gaps 47A between adjacent of the plurality of converging fingers 47 of the outer end cap 36B. Such overlap may act to reduce inadvertent lubricant loss, particularly when the caps 36A and B are nested in close tolerance with one another, so that the opposed surfaces of the respective end plates 41 contact each other for a tight fit. The above discussions of constricting and close fitting about the wire 18 also applies to the entry cap 38, including entry caps 38A and 38B. The end cap or caps 12 may form a perforated wiper, with a tight fit between end cap and wire. The use of a membrane style end may provide two layers of protection and overlap in the closed position. The caps 12 and cylindrical body 10 may be made of suitable materials, such as plastic rubber, PVC pipe, metal, or others.

Referring to FIG. 4A, the longitudinal wire insertion slots 32 and 33 may be sized with suitable cross-sectional arc length 44 relative to one another. In the example shown, the slots 32 and 33 are sized commensurate in a cross-sectional arc length 44 with one another. Each longitudinal wire insertion slot 32 may have a suitable cross-sectional arc length 44, such as 45 degrees or less. The longitudinal wire insertion slots 32 and 33 may allow for the placement or insertion of a wire 18 into the wire lubrication applicator 80 when the lateral entry 79 is defined.

Referring to FIGS. 1A-B, 2, and 4A-B, the wire lubrication applicator 80 may comprise a handle 50. The handle 50 may be mounted to the inner hollow tube 14, or at another suitable location such as on one or both the tubes 14 and 16. The handle 50 may be mounted to rotate the inner hollow tube 14 about the central axis 20. In the example shown the handle 50 may extend radially outward off of the cylindrical wall 26 of the inner hollow tube 14. The handle 50 may fit within an angular slot 54 defined in the cylindrical wall 27 of the outer hollow tube 16. The handle 50 may be mounted to rotate the inner hollow tube 14 about the wire travel axis 20 along the angular slot 54 that is defined in a cross-sectional arc along the cylindrical wall 27 of the outer hollow tube 16.

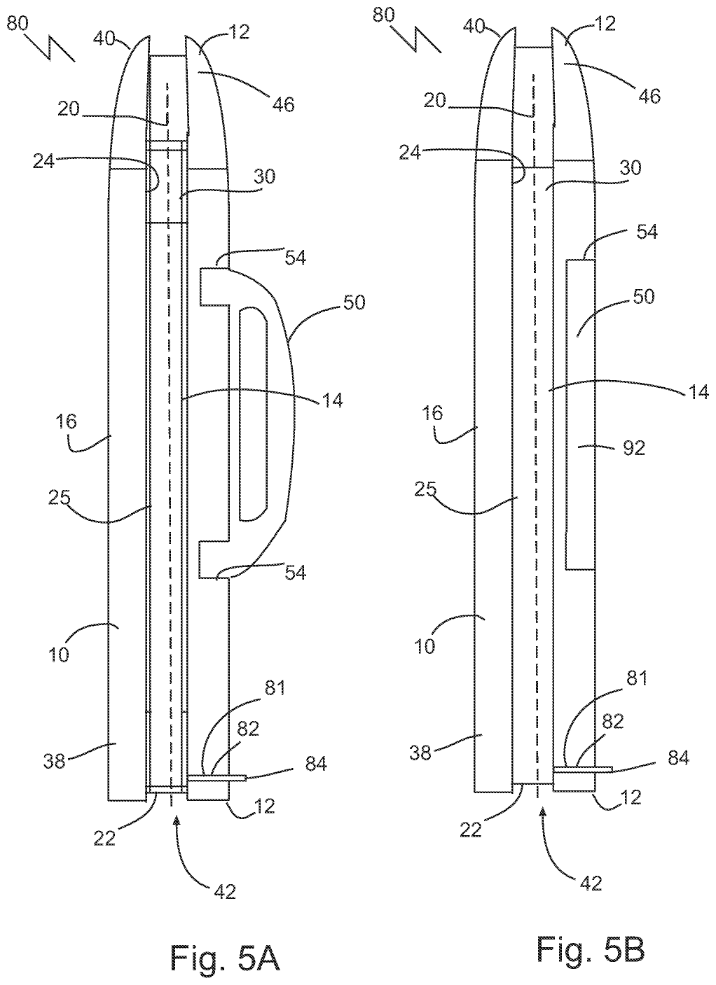

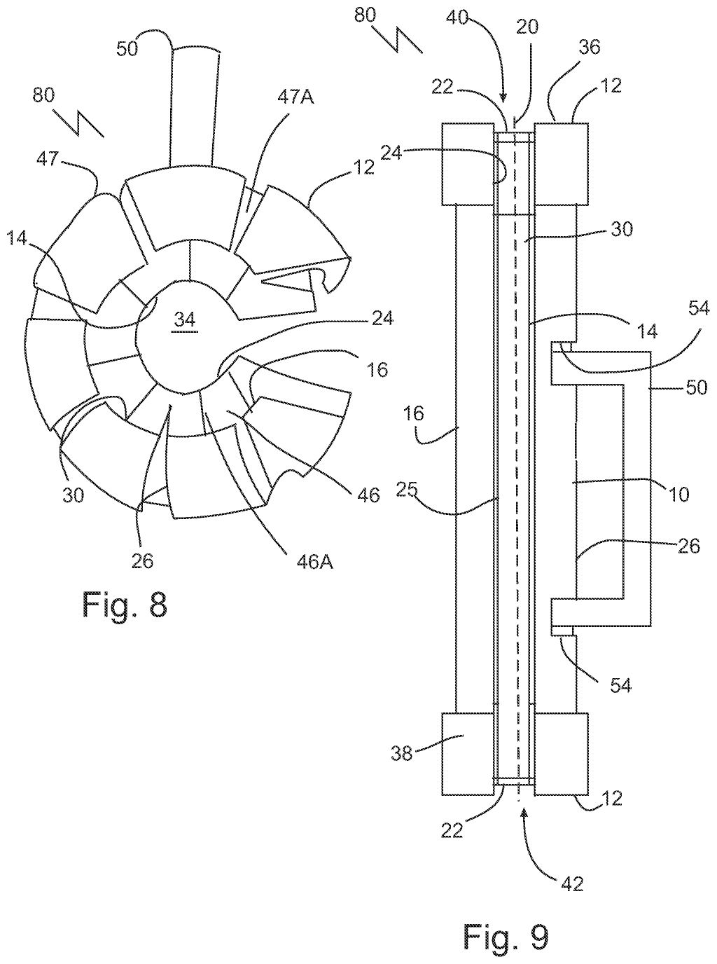

Referring to FIGS. 5A-B, a second embodiment of a wire lubrication applicator 80 is illustrated. The wire lubrication applicator 80 may have an axial wire opening 37 at cap 36 defined by a plurality of converging radial fingers 46 and/or 47. One or more of the ends 40 and 42 may be tapered, for example in the bullet shape shown for end 40. Tapering may refer to decreasing diameter along axis 20 away from an opposite axial end of the body 12. Referring to FIG. 8, an end view of the rounded or tapered bullet end 40 is illustrated, with fingers 46 and 47.

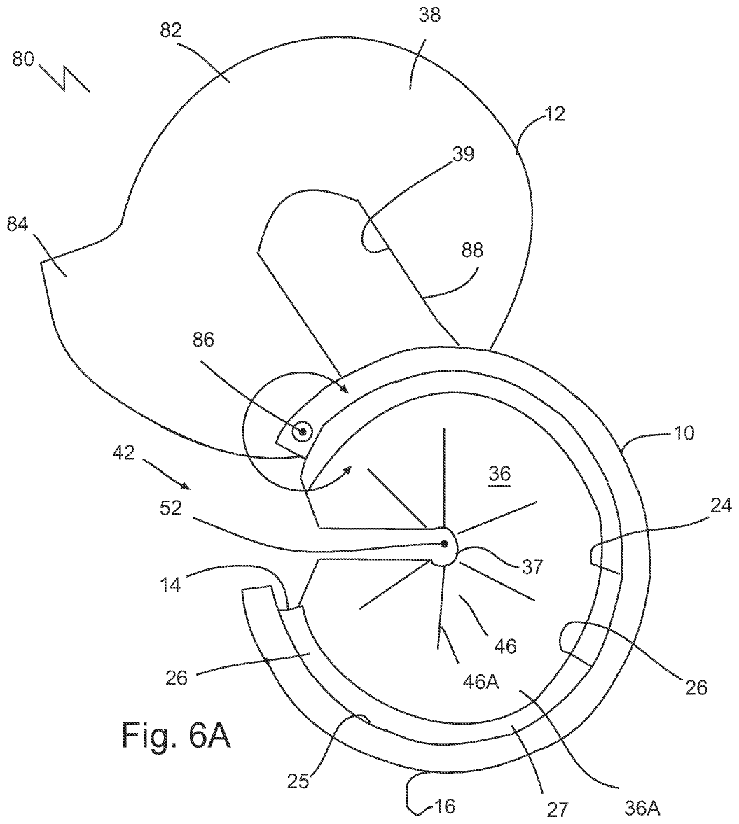

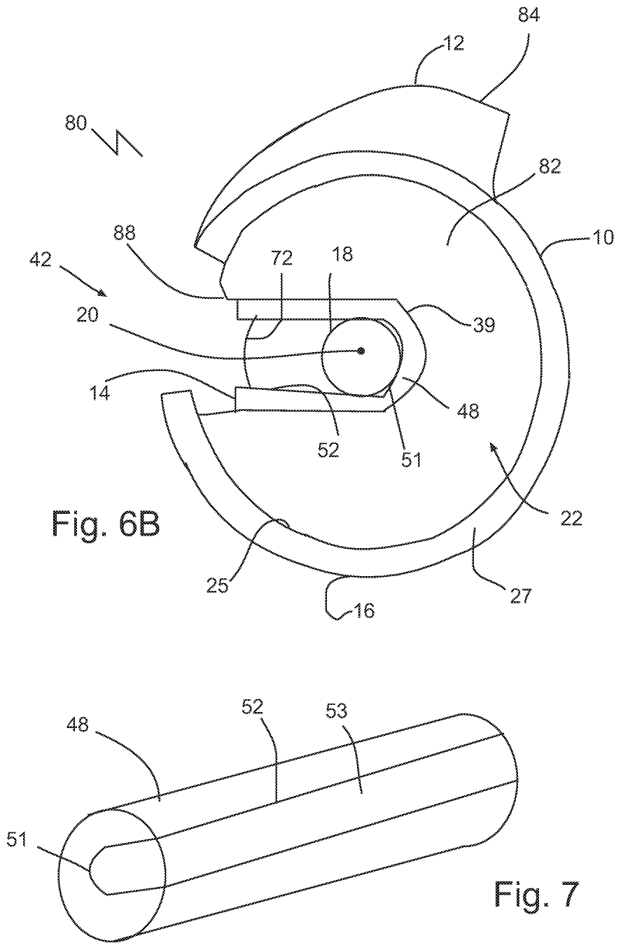

Referring to FIGS. 6A and 6B, the end caps 12 or a portion thereof may be moveable between an open position and closed position. The wire lubrication applicator 80 may have end caps 12 mounted to slide around an axis parallel to the wire travel axis 20 to facilitate the open and closed position. One or more of the end caps 12 may be mounted to slide around a longitudinal axis, such as defined by pivot axis 86 (FIG. 6A) parallel to the wire travel axis 20 of the cylindrical body 10 between the open position and the closed position. The sliding embodiment may be achieved using a plate or disc 82. The disc 82 may rotate about axis 86. The disc 82 may be mounted to slide about a slot 81 in the cylindrical wall 27 of the outer hollow tube 16. The disc 82 may have a handle portion 84 that extends radially outward beyond the cylindrical wall 27 of the outer hollow tube 16 to provide a mechanism that allows a user to open and close the disc 82.

Referring to FIGS. 6B and 7, the wire lubrication applicator 80 may comprise or operate with a lubrication material dispensing cartridge tube 48. Tube 48 may fit in use within the interior 24 of the inner hollow tube 14. The lubrication material cartridge tube 48 may define a longitudinal wire insertion slot 52 between opposed open axial cartridge ends. The lubrication material cartridge tube 48 may be used to place lubricating material into the wire lubrication applicator 80 before a wire is inserted. The cartridge tube 48 may provide a modular way of replacing or charging the interior 24 of the applicator 80 with lubricant during use and prior to application of the lubricant on a wire 18. The use of a cartridge may reduce the mess created during use, particularly to applicator 80. The cartridge tube may comprise a tube of silicon or other suitable lubricating materials. Referring to FIG. 7, the tube 48 may comprise a removable part covering the longitudinal slot 52, for example a tearaway or frangible part or strip 53. The cartridge may comprise axial wire openings 51 at opposed axial ends, in order to permit a wire 18 to pass through the interior of the cartridge tube 48. The use of a disc 82 may cooperate to seat a base of the cartridge tube 48 in use.

Referring to FIGS. 5A-B, the applicator 80 may incorporate a relatively larger handle 50 than in the embodiment of FIG. 1A. The handle 50 may be formed of two or more columns 90 and a bridge portion 92 defining a hand-receiving aperture 94, which may be sized to fit one, two, or more fingers of an average adult user. Each column 90 may fit within a respective angular slot 54 in the outer hollow tube 16. By mounting the handle 50 on the inner tube 14, the user may grasp the outer tube 16 and rotate the handle 50 to relatively rotate the tubes 14 and 16. Referring to FIG. 9, an embodiment is illustrated that combines the two column handle 50 of FIG. 4A with the body 10 and parts of the embodiment of FIG. 1A.

Referring to FIGS. 1A-1B and 4A-4B, a method of applying lubricant to a wire 18 is illustrated. The tubes 14 and 16 may be rotated relative to one another to align the respective longitudinal slots 32 and 33, respectively, to define the lateral wire entry 79. Once aligned, a wire 18 may be laterally inserted into the axial wire travel passage 30 or lubricant retaining interior as shown. The wire lubrication applicator 80 may then be translated, for example moved axially along the wire 18, to dispense lubrication material 72, for example a penetrating or coating lubricant based on the intended use of the wire or wire 18. At a suitable point in the process, for example before translating, the lubricant retaining interior may be charged with lubrication material into the interior 24 of the inner hollow tube 14. In one case charging includes inserting a cartridge tube 48 in the interior 24. In the example shown a supply of suitable lubricant may be inserted, for example injected or poured into the interior 24. Before translating, the inner and outer hollow tubes 14 and 16 may be rotated coaxially relative to one another to close the lateral wire entry 79. Once lubricant has run out or lubrication application is complete, the tubes 14 and 16 are rotated to open the applicator 80, by aligning the slots 32 and 33, and the wire 18 may be laterally removed from the interior 24.

The method may include one or more steps, for example one or more of:

a. Step one—Select the correct applicator size for the application. (Example: for
a ¾″ conduit/raceway wire installation you would select and use the small Lube Tube)
b. Step two—Fill the applicator with lubricant.
c. Step three—Slide wires into the applicator and rotate the guard cylinder to the closed position in order to ensure that the wires and lubricant can't fall out during usage.
d. Step Four—Pull wires through the applicator and into the conduit/raceway as required. Note: (Monitor the applicator to ensure that the consistent amount of lubricant hasn't run out. If the lubricant cylinder is empty, repeat steps one-three.)
e. Step Five—Open the applicator, remove and clean off the wires from any excess lubricant and store the applicator away until the next usage.

A suitable lubricant may be used. In one case, a lubricant known as YELLOW 77™ by IDEAL INDUSTRIES™ may be used. A lubricant may be selected to be age to use with most wire types. A lubricant may be selected to cling to wire throughout long runs, even where moisture is present. A lubricant may be selected to remain temperature stable across a wide range of temperatures, for example from 32° F. to 130° F. (0° C. to 54° C.). A lubricant may be selected to dry slowly to a thin, non-conductive film that won't harden in conduit. A lubricant may be selected to be environmentally safe—for example non-toxic, non-flammable and non-corrosive. Polyethylene Glycol and variants may be used, such as polyethylene glycol ester. Other compounds may be used with the glycol ester, such as water, ethoxylated tallow amine, and acrylamide sodium acrylate copolymer with trideceth-6. One or more antimicrobial agents or pigments may be used.

The applicator 80 may comprise two cylinders that interconnect together creating one double walled single tube/cylinder. The inner cylinder may act as a container to fill YELLOW 77™ lubricant into it and the outer cylinder acts as the containment guard to prevent the wires and lubricant from falling out of the cylinder during usage. Perforated end caps may be on both ends of the cylinders to allow only the wires to flow through them and enable only the exact required lubricant to be applied. The applicator may solve an everyday issue in the industry when installing multiple wires into a conduit/raceway while at the same time, trying to consistently lubricate the wires as required. More often than not, the lubricant primarily ends up everywhere and anywhere accept on the wires or inside the conduit/raceway creating an inconsistent lubricant application and additional lubricant wastage leaving an unnecessary mess to clean up after every installation.

The cylinders/tubes may be designed to contain the lubricant in order for multiple quantities of wire and different wire gage sizes can flow through them during installations. (Example: 10C #14 AWG wires or 4C #6 AWG wires etc.) The small applicator 80 may be approximately 2½″ in diameter and 12″ in length and the large applicator 80 may be approximately 4″ in diameter and 16″ in length. Both the small and large applicators may have a split down the spine and perforated end caps so that the wires can travel easily through them during usage. Both sizes may be constructed with a second or outer cylinder/tube creating a double wall feature. The inner lubricant containment cylinder may contain the lubricant and an external containment cylinder acts as a guard to ensure that once it is in the closed position, the lubricant and the wires cannot exit out of the applicator during usage. As the wires travel through the applicator, physics naturally takes over and only the exact required amount of lubricant will automatically apply itself to the wires providing a consistent distribution of lubricant directly onto the wires and into the conduit/raceway providing maximum efficiency and with very minimal wastage or mess during any installation.

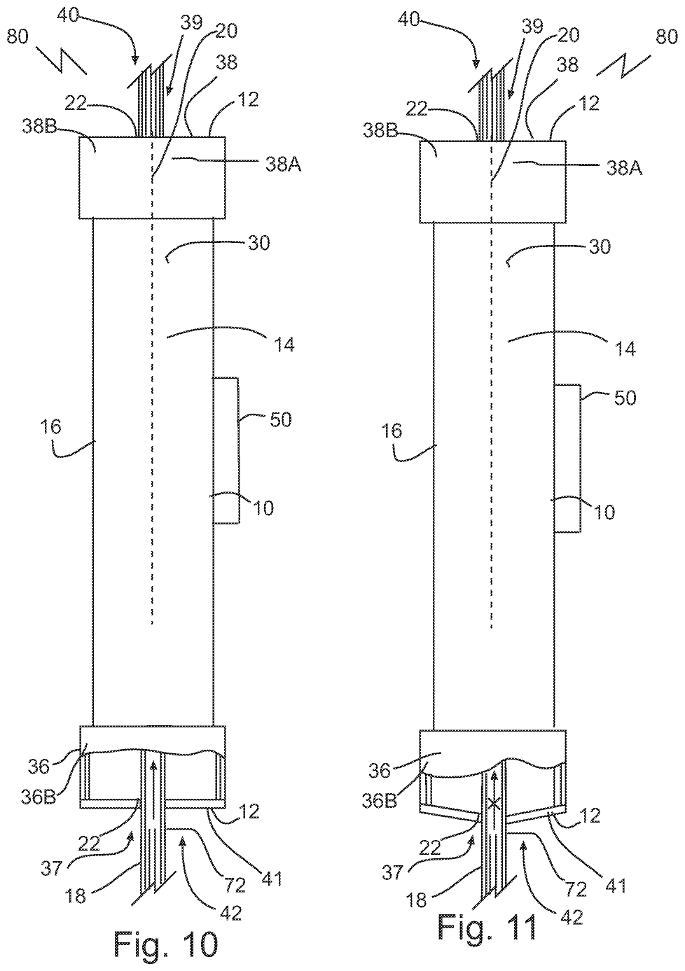

Referring to FIGS. 10 and 11, at least one of the end caps 12 may be structured to grip the wire or cable(s) 18. At least one of the end caps 12 may be structured to permit axial translation of the wire in a first axial direction along the cable 18, for example as shown in FIG. 10). The end cap 12 may be structured to grip the cable 18 when attempting to axial translate the applicator along the cable 18 in a second axial direction opposite the first direction (FIG. 11). In the example shown, the one-way gripping is achieved using an end plate 41 that functions as a one-way valve, by pinching the cable 18 when under axial load in the second direction (FIG. 11). The end plate 41 may have a suitable shape, such as a conical or planar shape in a neutral, unloaded position. The plate 41 may define the opening 37, whose circumferential or other shaped edge profile may contact and grip the cable 18. The cable 18 may comprise plural cables as shown. In other cases, the end cap 12 may be switchable between a gripping and ungripping position, for example if the end cap has an actuator to move it between positions. The applicator may thus be designed to have end caps which in an open position allow a free flow of wires during application and in a closed position have a gripping ability restricting the flow of wires to the other direction for assistance in installation.

The applicator may be relatively light weighted but constructed of two hard plastic cylinders for durability with perforated end caps that connect together and act as a double walled single cylinder. The unique design of the applicator may provide flexibility for the user to detach and re-attach onto the wires in multiple locations during usage where previously for whatever reasons such as accessibility was not an option. (Example: installations behind existing pipes, equipment, high elevations etc.) The applicator may provide the user confidence that the lubricant will be applied consistently, correctly and with maximum precision every time.

Testing by comparing the performance of the applicator 80 over conventional methods of applying lubricant to wires 18. During a conventional method of installation, overall, approximately 25-30% more lubricant was used during this installation as compared with the use of the applicator 80. Additionally, only approximately 40-50% of the lubricant applied during this installation actually consistently went directly onto the wires and the rest was direct spillage and or extra wastage. This installation also took the electricians approximately 15-20% longer in general per install using conventional methods then with applicator 80 use. During each wire installation test, the same electricians were used, a new container of Yellow 77™ lubricant was provided and the conduits runs were the same. However, the efficiency differences/results from these tests are very substantial. These differences in some cases may be enough to enable a contractor to complete a project on time and or on budget resulting with potentially more profit.

The applicator may be designed and constructed to be a single re-fillable cylinder that can be re-used multiple times over. However, another optional design is to provide a pre-filled cylinder/cartridge that simply slides into the guard cylinder instead of re-filling the lubricant holding cylinder every time once it is empty.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A wire lubrication applicator comprising:
a cylindrical body with opposed open axial ends along a wire travel axis, the cylindrical body formed of inner and outer hollow tubes that each define a longitudinal wire insertion slot extending between the opposed open axial ends, with the inner and outer hollow tubes being coaxially mounted to rotate relative to one another about the wire travel axis to align and misalign the longitudinal wire insertion slots to open and close, respectively, a lateral wire entry into a lubricant retaining interior of the inner hollow tube; and
one or more end caps that are on the cylindrical body and each form an axial wire opening, with one or more of the axial wire openings being biased to radially constrict about a wire in use.

2. The wire lubrication applicator of claim 1 in which the one or more end caps comprise:
a wire exit cap at a wire exit end of the opposed open axial ends; and
a wire entry cap at a wire entry end of the opposed open axial ends.

3. The wire lubrication applicator of claim 1 in which one or more of the end caps have a plurality of converging radial fingers that define the respective axial wire opening.

4. The wire lubrication applicator of claim 3 in which:
the one or more of the end caps that have a plurality of converging radial fingers further comprises inner and outer end caps nested coaxially with one another;
the inner end cap is connected to the inner hollow tube, and the outer end cap is connected to the outer hollow tube; and
when the lateral wire entry is closed, the inner and outer end caps are angularly displaced relative to one another such that the plurality of converging fingers of the outer end cap overlaps radial gaps between adjacent of the plurality of converging fingers of the inner end cap.

5. The wire lubrication applicator of claim 1 in which one or more of the end caps are reversibly detachable from the lubrication applicator.

6. The wire lubrication applicator of claim 1 in which one or more of the end caps are movable between an open position and a closed position.

7. The wire lubrication applicator of claim 6 in which one or more of the end caps are mounted to slide around a longitudinal axis parallel to the wire travel axis of the cylindrical body between the open position and the closed position.

8. The wire lubrication applicator of claim 1 further comprising a handle.

9. The wire lubrication applicator of claim 8 in which the handle extends radially outward off of the cylindrical wall of the inner hollow tube.

10. The wire lubrication applicator of claim 9 in which the handle is mounted to rotate the inner hollow tube about the wire travel axis along an angular slot defined in a cross-sectional arc along the cylindrical wall of the outer hollow tube.

11. The wire lubrication applicator of claim 1 in which the inner and outer hollow tubes are between 2-5 inches in diameter and 10-18 inches in length.

12. The wire lubrication applicator of claim 1 further comprising a lubrication dispensing cartridge within the inner hollow tube.

13. The wire lubrication applicator of claim 13 in which the lubrication dispensing cartridge defines a longitudinal wire insertion slot that extends between opposed open axial cartridge ends and aligns with the longitudinal wire insertion slots of the inner and outer hollow tubes when the lateral wire entry is open.

14. The wire lubrication applicator of claim 1 in which the longitudinal wire insertion slots are commensurate in cross-sectional arc length with one another.

15. The wire lubrication applicator of claim 1 in which each longitudinal wire insertion slot has a cross-sectional arc length of 45 degrees or less.

16. The wire lubrication applicator of claim 1 further comprising lubrication compound within the lubricant retaining interior.

17. The wire lubrication applicator of claim 1 in which one of the end caps is structured to grip the wire.

18. A wire lubrication applicator comprising:
a cylindrical body with opposed open axial ends along a wire travel axis, the cylindrical body formed of inner and outer hollow tubes that each define a longitudinal wire insertion slot extending between the opposed open axial ends, with the inner and outer hollow tubes being coaxially mounted to rotate relative to one another about the wire travel axis to align and misalign the longitudinal wire insertion slots to open and close, respectively, a lateral wire entry into a lubricant retaining interior of the inner hollow tube; and
one or more end caps that are on the cylindrical body and each form an axial wire opening, with one or more of the end caps having a plurality of converging radial fingers that define the respective axial wire opening.

19. A method of using the wire lubrication applicator of claim 1, the method comprising:
inserting a wire laterally through the lateral wire entry into the lubricant retaining interior, through the aligned longitudinal wire insertion slots of the inner and outer hollow tubes; and
translating the wire lubrication applicator axially along the wire to dispense lubrication material from the lubricant retaining interior onto the wire.

20. The method of claim 19 further comprising, before translating, charging the lubricant retaining interior with lubrication material.

21. The method of claim 19 further comprising, before translating, rotating the inner and outer hollow tubes coaxially relative to one another to close the lateral wire entry.
